(19) United States
(12) Patent Application Publication
(10) Pub. No.: US 2022/0222736 A1
(43) Pub. Date: Jul. 14, 2022

(54) SYSTEMS AND METHODS FOR ELECTRONIC SUBSCRIPTION MANAGEMENT

(71) Applicant: Bit Gooey Inc., Salt Lake City, UT (US)

(72) Inventor: Christopher Alexander Burns, Salt Lake City, UT (US)

(21) Appl. No.: 17/148,839

(22) Filed: Jan. 14, 2021

(51) Int. Cl. G06Q 30/06; G06Q 20/12; G06Q 20/14

(52) U.S. Cl. CPC G06Q 30/0637; G06Q 20/14; G06Q 20/123

(57) ABSTRACT

A system for facilitating the creation, maintenance, and management of customer subscriptions for existing websites without subscription features. A company may use the system to handle customer payments, assign customer access, perform administrative tasks, or handle customer receipts depending on the configuration selected by the company. The system may provide a company with mechanisms to access databases storing information needed to sell subscriptions and bill customers for subscriptions in a fully automated manner. The system may integrate e-commerce websites, point of sales systems, and other electronic storefronts using an adapter module, allowing easy creation of additional e-commerce products, within an existing website, in order to sell subscriptions.

### TECHNICAL FIELD

The present disclosure is related to electronic payment and subscription management systems and methods, and more particularly to electronic payment and subscription management systems and methods for integration with existing websites.

### BACKGROUND

Electronic subscription services are increasingly being utilized by consumers. For example, utility bills, entertainment, and even groceries may now be purchased and packaged as a subscription product. However, it may be difficult to set up an electronic subscription management platform in a secure and industry compliant manner. For example, a company attempting to set up an electronic subscription management platform may need to comply with PCl/DSS (Payment Card Industry Data Security Standards). Such compliance may be cumbersome and expensive. Additionally, a company that is transitioning its products and services to digital formats may see a reduced quality in its products and services. For example, the company might under-predict demand for their digital products, leaving them understaffed and unable to fulfill their orders. Finally, a company that has an existing website for handling e-commerce may face difficulties when updating the website to handle subscription and recurring payments. Accordingly, improvements in electronic subscription management techniques are needed.

### SUMMARY

Methods and systems are disclosed for facilitating the electronic management of subscriptions. A system may comprise a website including a first database and a billing system including a second database. At least one computing device in communication with the website and the billing system may be configured to retrieve, from the first database, a plurality of customer orders and determine that a first set of customer orders from the plurality of customer orders includes a subscription order. The at least one computing device may process each customer order from the first set of customer orders to determine a first subset of customer orders including a new subscription order and a second subset of customer orders including an existing subscription order. For each customer order in the first subset, the at least one computing device may generate data associated with the new subscription order and send the newly generated data to the second database. For each customer order in the second subset, the at least one computing device may update data associated with the existing subscription order and send the updated data to the second database.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates a block diagram of an example system according to an embodiment of the present disclosure;

FIG. 2. illustrates a flow chart of an example rebilling method according to an embodiment of the present disclosure;

FIG. 3 illustrates a flow chart of an example payment method according to an embodiment of the present disclosure;

FIG. 4 illustrates a flow chart of an example order fulfillment method according to an embodiment of the present disclosure; and

FIG. 5 illustrates of an example computing device according to an embodiment of the present disclosure.

### DETAILED DESCRIPTION

It may be advantageous for a company to electronically manage subscriptions to its products or services. For example, a company that electronically manages subscriptions to its products or services may be able to set up recurring billing and automatically send alerts to consumers as a convenience. However, a company that wants to manage its subscriptions electronically may face difficulties. For example, the company must set up its subscription management platform in a manner compliant with PCl/DSS. Such compliance may be cumbersome and expensive. Compliance with PCl/DDS may be particularly cumbersome and expensive for a company with existing credit card payment solutions. Companies with existing credit card payment solutions must ensure not only that its new subscription payment methods comply with PCl/DSS, but it must ensure that its old payment methods do so as well. To comply with PCl/DDS, the company may also need to keep each of its payment methods separate from each other using physical security at the network layer or may be required to develop and document a set of stringent security protocols and regularly occurring processes. For a company that does not already possess specialized knowledge related to network security, this task becomes a monumental undertaking.

A company that is transitioning its products and services to digital formats may see a reduced quality in aspects of its products and services. For example, the company might under-predict demand for their digital products, leaving them understaffed and unable to fulfill their orders. This may cause increased difficulty running digital services or handling customer inquiries. For example, a sudden and unexpected increase in website traffic could cause outages for paying subscribers to digital services. As another example, a sudden increase in telephone inquiries could create a long wait time to speak to a customer representative. As a result, the quality of products or services and the overall branding could be drastically decreased. Additionally, many companies already have existing websites that handle ecommerce. However, upgrading the existing website to handle subscription and recurring payments may be difficult, impossible, or too cost prohibitive due to software development fees.

A company that wants to manage its subscriptions electronically may face the above difficulties regardless of the type of product or service it sells and regardless of its size. For example, a traditional live events company may earn the majority of its income from training seminars, workshops, and other events. The traditional live events company may already have an existing website that handles ecommerce. Video recordings of the live events could be created and sold as digital subscription products. By selling these video recordings as digital subscription products, the company may reach a much broader audience. However, the company may need to entirely overhaul its existing business before launching its new digital subscription products. Large, medium, or small-sized companies may all face the above difficulties when managing its subscriptions electronically.

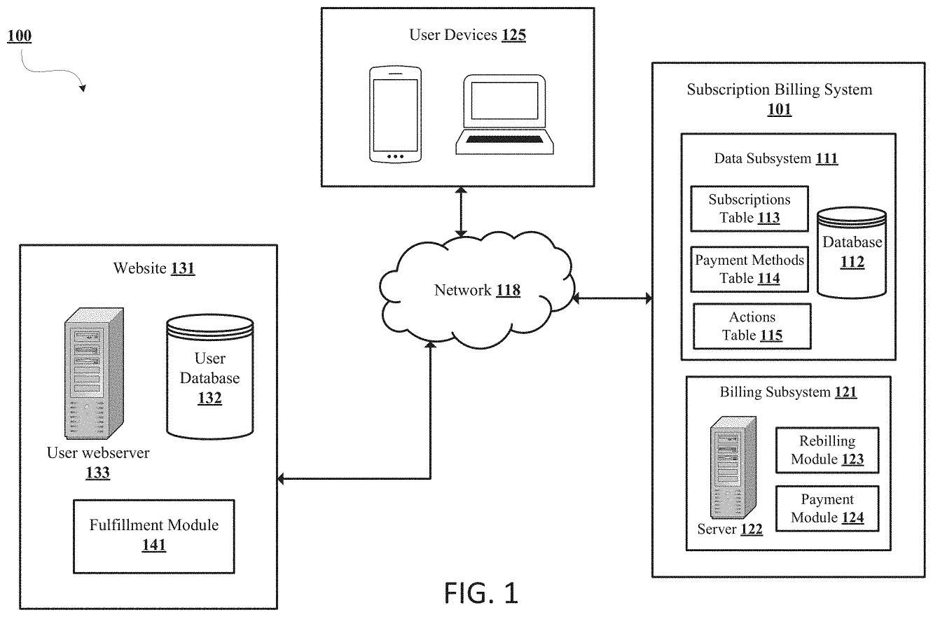

A company may want to manage its subscriptions electronically while avoiding the challenges described above. FIG. 1 illustrates an exemplary system 100 for integrating a subscription management platform with an existing website. The system 100 may allow a company to avoid the prohibitive e-commerce compliance requirements by providing features that can be integrated with an existing website of any type or construction. The system 100 may also allow a company to automate tasks related to subscriptions and recurring billing, such as self-management customer portals, automatic recurring billing, customer access management, and customer alerts for billing notices. Thus, use of the system 100 may allow a company that would otherwise face difficulties in managing its subscriptions electronically to more easily and effectively launch a subscription product or service with recurring billing. While the system 100 may be most beneficial to a company that is on the road to enterprise but not yet arrived, it can also benefit more well-established companies. The system 100 may benefit companies of sizes, including smaller, medium, or large sized companies.

The system 100 includes a subscription billing system 101, at least one user device 125, and a website 131. The subscription billing system 101, the at least one user device 125, and the website 131 are in communication via a network 118. The subscription billing system 101 and the website 131 may be associated with a business entity seeking to manage its subscriptions electronically, such as the companies described above.

The subscription billing system 101 may include a data subsystem 111 and a billing subsystem 121. The data subsystem 111 may manage all data required for the functioning of the subscription billing system 101. Such data may be stored in a database 112 that may facilitate the storage of the data associated with a subscriptions table 113, a payment methods table 114, and an actions table 115. Data associated with the subscriptions table 113 may indicate information related to one or more subscriptions, such as each subscription's unique ID, its rebilling renewal date, and the unique ID of a customer associated with the subscription as stored in the user database 132. Data associated with the payment methods table 114 may indicate information related to secure credit card information associated with a unique customer ID. Data associated with the actions table 115 may indicate actions that have been taken against subscriptions in the past, based on their unique subscription ID. However, the database 112 may not store tables including customer data or order data, as this information may be stored within an established e-commerce website, such as the website 131, in communication with the subscription billing system 101.

The billing subsystem 121 may include a server 122 that runs a rebilling module 123 and a payment module 124. The rebilling module 123 and the payment module 124 may be integrated with each other and may, in conjunction with each other, manage subscription renewals and handle submitted payments for processing. The server 122 may be any platform capable of executing code. The billing subsystem 121 may contain code necessary for integration of the subscription billing system 101 with the website 131

The website 131 may be an existing e-commerce website. The website 131 may comprise a user database 132, a user webserver 133, and a fulfillment module 141 that is configured to respond to completed orders and integrate the subscription billing system 101 with the user website 131. The user webserver 133, which may be any computing platform or cluster of computing platforms that can power a website, may house the fulfillment module 141. The user webserver 133 may run the fulfillment module 141 via a webserver or any clustered or scalable configuration thereof. The user database 132 may contain data indicative of orders and customers associated with the orders. The billing subsystem 121 of the subscription billing system 101 may contain code necessary for the fulfillment module 141 to be capable of integrating the subscription billing system 101 with the user website 131. Users may connect to the website 131 via one or more user devices 125. In an embodiment, the users may connect to the website 131 via the one or more user devices 125 without interacting directly with the subscription billing system 101. Rather, the user would interact with the user interface of the website 131 to order and renew subscriptions and the like, and the website 131 would send any data necessary for fulfillment of such subscriptions to the separate subscription billing system 101 for processing. The user devices 125 may be comprised any of a variety of different types of wireless devices, including for example, a smartphone, a tablet computer, a laptop computer, a notebook computer, a personal computer, other consumer electronics, and the like.

The network 118 may comprise one or more public networks (e.g., the Internet) and/or one or more private networks. A private network may include a wireless local area network (WLAN), a local area network (LAN), a wide area network (WAN), a cellular network, or an intranet. The network 118 may comprise wired network(s) and/or wireless network(s).

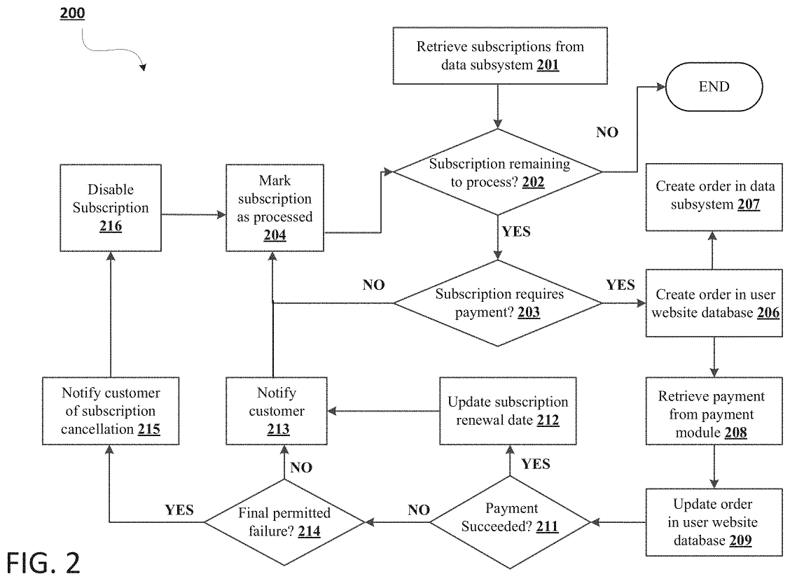

The billing subsystem 121 may implement a number of the functions and techniques described herein. For example, as illustrated in FIG. 2, the rebilling module 123 may, in conjunction with the payment module 124 and data subsystem 111, implement a method 200 to manage subscriptions renewals. As further explained below, the rebilling module 123 may start by retrieving subscription data from the data subsystem 111, and for each subscription, determine whether the subscription requires payment. For subscriptions that require payment, the rebilling module 123 may then create an order associated with the subscription and retrieve payment for the order from the payment module 124. If payment for the order is successful, the rebilling module 123 may update the subscription renewal date and notify the customer that placed the order. If payment for the order is not successful, the rebilling module 123 may either disable the subscription or notify the customer that payment was unsuccessful.

At step 201, the rebilling module 123 may retrieve, from the data subsystem 111, subscription data. The subscription data may be associated with subscriptions that are past due for rebilling, based on their renewal date listed in the data subsystem 111. For example, the subscription billing system 101 may retrieve subscription data from the database 112. Subscription data retrieved from the database 112 may be associated with the subscriptions table 113. As discussed above, data associated with the subscriptions table 113 may indicate information related to one or more subscriptions, such as each subscription's unique ID, its rebilling renewal date, and the unique ID of a customer associated with the subscription as stored in the user database 132. Subscription data retrieved from the database 112 may also be associated with the payment methods table 114. As also discussed above, data associated with the payment methods table 114 may indicate information related to secure credit card information associated with a unique customer ID. Subscription data retrieved from the database 112 may also be associated with the actions table 115. Data associated with the actions table 115 may indicate actions that have been taken against subscriptions in the past, based on their unique subscription ID.

The rebilling module 123 may enter a loop where all subscriptions returned will be iterated upon in sequence by unique subscription ID until none are remaining, at which point the program ends. At step 202, it may be determined whether there remains a subscription to process. If there are no more subscriptions to process, the method 200 may end. Conversely, if there remains a subscription to process, the method 200 may proceed to step 203.

At step 203, the rebilling module 123 may determine whether a subscription requires payment. To determine whether a subscription requires payment, the rebilling module 123 may check the subscription data retrieved at step 201, including current renewal date, subscription status, and subscription price associated with each unique subscription ID. Based on this subscription data, the rebilling module 123 may determine if billing action is required for the subscription. If the rebilling module 123 determines that billing action is not required, the method may proceed to step 204 where the subscription may be marked as processed. After the subscription is marked as processed, the rebilling module 123 may re-enter the loop at step 202 where it will determine if there are any more subscriptions to process. Conversely, if the rebilling module 123 determines that billing action is required, the module may proceed to step 206.

At step 206, the rebilling module 123 may create an order in the user website database 132. The created order may be integrated with the user website 131. In addition to creating the order in the user website database 132, the rebilling module may create an order in the data subsystem 111. For example, at step 207, another order may be created. This other order may be based on the order created in the user website database 132 and it may be linked to the user and subscription in the subscription table 113 of the data subsystem database 112.

At step 208, the rebilling module 123 may retrieve payment from the payment module 124. For example, the rebilling module 123 may retrieve payment from the payment module 124 using the order's unique order ID stored in the user database 132 of the user website 131. At step 209, the rebilling module 123 may update the order in the user website database 132. To update the order in the user website database 132, the rebilling module may push the order results from the payment module 124 to the user website 131.

At step 211, the rebilling module 123 may determine whether the payment was successful. If the rebilling module 123 determines that the payment was successful, the method 200 may proceed to step 212. Conversely, if the rebilling module 123 determines that payment was not successful, the method 200 may proceed to step 214.

At step 212, the rebilling module 123 may update the subscription renewal date. To update the subscription renewal date, the rebilling module 123 may push updates for the renewal date in the subsystem database 112 so that the customer associated with the subscription is not immediately rebilled. The method 200 may then proceed to step 213 to notify the customer that the subscription renewal data has been updated. To notify the customer that the subscription renewal data has been updated, the rebilling module 123 may trigger the normal means of communication existing in the user website 131. Once the customer has been notified that the subscription renewal data has been updated, the method may proceed to step 204 where the subscription may be marked as processed. After the subscription is marked as processed, the rebilling module 123 may re-enter the loop at step 202 where it will determine if there are any more subscriptions to process.

At step 214, the rebilling module 123 may determine whether final failure is permitted, i.e., whether no further rebilling will be attempted. To determine whether final failure is permitted, the rebilling module 123 may determine whether this is the final billing failure. If this is not the final billing failure, the method 200 may proceed to step 213 to notify the customer that this is not the final billing failure. To notify the customer that this is not the final billing failure, the rebilling module 123 may trigger the normal means of communication existing in the user website 131. Once the customer has been notified, the method 200 may proceed to step 204 where the subscription may be marked as processed. After the subscription is marked as processed, the rebilling module 123 may re-enter the loop at step 202 where it will determine if there are any more subscriptions to process.

If the final billing failure is allowed, the method 200 may proceed to step 215 where the customer may be notified that the subscription has been cancelled. To notify the customer that his or her subscription has been cancelled, the rebilling module 123 may trigger the normal means of communication existing in the user website 131. At step 216, the subscription may be cancelled or disabled. To disable the subscription, the rebilling module 123 may update the unique ID associated with the subscription that is stored in the data subsystem database 112 to a disabled state. After the subscription has been cancelled, the method 200 may proceed to step 204 where the subscription may be marked as processed. After the subscription is marked as processed, the rebilling module 123 may re-enter the loop at step 202 where it will determine if there are any more subscriptions to process.

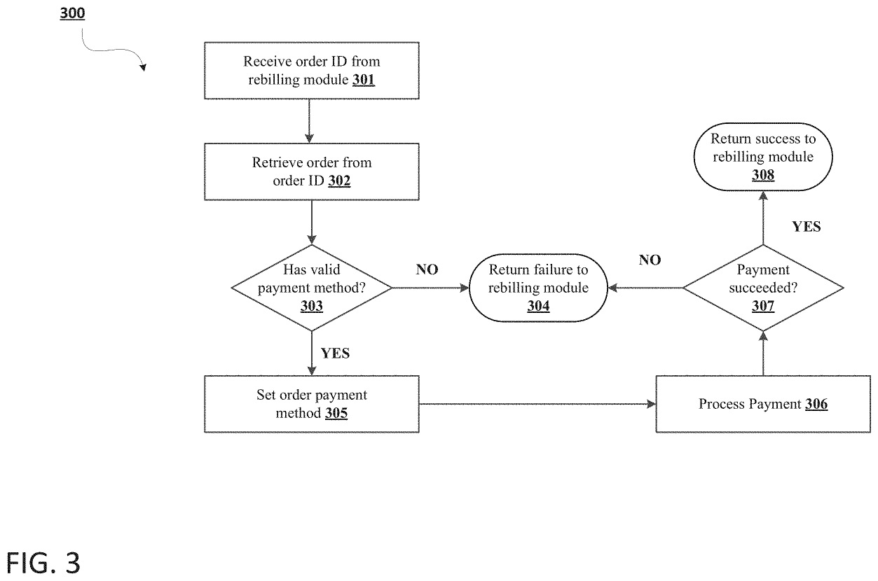

As discussed above, the rebilling module 123 interacts with both the payment module 124 and the data subsystem 111 to manage subscription renewals. For example, at step 208 of method 200, the rebilling module 123 may retrieve payment from the payment module 124. While FIG. 2 focuses on the functions and techniques that may be implemented by the rebilling module 123 during the subscription renewal process, FIG. 3 instead focuses on the functions and techniques that may be implemented by the payment module 124 during the subscription renewal process. FIG. 3 illustrates a method 300 that may be implemented by the payment module 124. The method 300 may be implemented by the payment module 124 to process payments associated with each customer order. Once processed, these payments may be sent to the rebilling module 132.

At step 301, the payment module 124 may receive an order ID from the rebilling module 123. The payment module 124 may be executed by the rebilling module 123. In an embodiment, the payment module 124 may receive only the unique order ID from the user website 131. Once the payment module 124 receives the order ID from the rebilling module, the payment module 124 may, at step 302, retrieve the order based on the order ID. The payment module 124 may retrieve the full order associated with the order ID. For example, the full order may include all product information associated with the order and the final price of the order.

At step 303, the payment module 124 may determine whether the customer associated with the order has valid payment method stored in the payment methods table 114 of data subsystem 111. For example, the payment module 124 may determine whether the customer associated with the order has a valid credit card number stored in the payment methods table 114 of the data subsystem 111. If a customer has more than one payment method stored in the payment methods table 114 of the data subsystem 111, the payment module 124 may check each of the stored payment methods for a valid payment method. If one of the payment methods is stored as the default payment method, the payment module 124 may first check if the default payment method is valid before checking if the other payment methods are valid. If the payment module 124 determines that a valid payment method does not exist, the method 300 may proceed to step 304. At step 304, the payment module 124 may return the failure to the rebilling module 123 and the method 300 may end.

Conversely, if the payment module 124 determines that a valid payment method does exist, the method 300 may proceed to step 305. At step 305, the payment order module 124 may set a payment method for the order. The payment method for the order may be the payment method found to be valid in step 303. For example, the payment method may be the default payment method stored in the payment methods table 114 of the data subsystem 111 if the default payment method is found to be valid. To set the payment method for the order, the payment module 124 may update all of the associated payment information for that order in the user website database 132 and the method 300 may proceed to step 306.

At step 306, the payment module 124 may process the payment. To process the payment, the payment module 124 may send the customer's payment information, such as the payment method set for the order in step 305, to a payment processor. The results of the payment processing, such as whether the payment was successful or not, may be stored in the user website database 132. At step 307, the payment module 124 may determine if the payment succeeded. If the payment was not successful, the method may proceed to step 304. At step 304, the payment module 124 may return the failure to the rebilling module 123 and the method 300 may end. Conversely, if payment succeeded, the method 300 may proceed to step 308. At step 308, the payment module 124 may return the success to the rebilling module 123 and the method 300 may end.

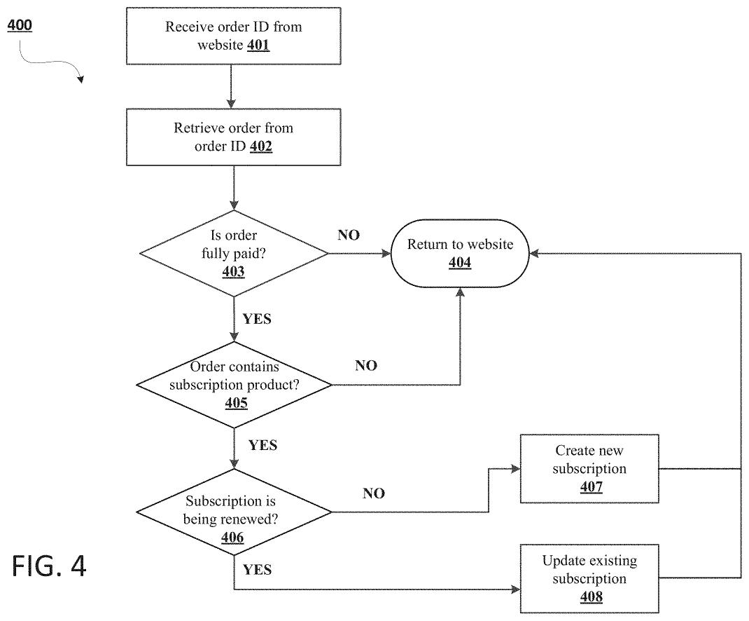

As discussed above, the fulfillment module 141 may seamlessly integrate the subscription billing system 101 with the user website 131. FIG. 4 illustrates a method 400 that may be implemented by the fulfillment module 141 in order to integrate the subscription billing system 101 with the user website 131. At step 401, the fulfillment module 141 may receive an order ID from the website 131 based on the user interface of the website 131. When the fulfillment module 141 receives an order ID from the website 131, the method 400 may be initiated. In an embodiment, the fulfillment module 141 may receive only the unique ID associated with an order. At step 402, the fulfillment module 141 may retrieve an order associated with the order ID. For example, the fulfillment module 141 may retrieve, from the database 132, the full content of the order, including all ordered products and services and the order's payment status.

At step 403, the fulfillment module 141 may determine whether the order is fully paid for. The fulfillment module 141 may determine that the order is fully paid for if the payment is marked as completed. The payment may be marked as completed if it has been successfully processed by the payment module 124. If it is determined that the order is not fully paid for, then the method 400 may proceed to step 404 where control is returned to the website 131 and the method 400 ends. Conversely, if it is determined that the order is fully paid for, then the method 400 may proceed to step 405. At step 405, the fulfillment module 141 may determine whether the order contains a subscription product. If the fulfillment module 141 finds that the order does not contain a subscription product, the method may proceed to step 404 where control is returned to the website 131 and the method 400 ends. Step 405 makes it possible for the website 131 to process subscription orders exactly like it would process any other order and without requiring subscription processing capabilities. All orders, whether they contain subscriptions or not, are sent to the fulfillment module 141, which then sorts the orders to determine if any subscriptions are included in the order. If not, then the fulfillment module 141 returns control to the website 131 for everything and if it does, the subscription is essentially pulled out and processed and then control is returned to the website 131 for everything else.

Conversely, if the order does contain a subscription product, the method 400 may proceeds to step 406. At step 406, the fulfillment module 141 may determine whether the subscription is being renewed. A subscription may be being renewed if this is not the customer's first time subscribing to the product or service. As a result, the fulfillment module 141 may determine that a subscription is being renewed if this is not the customer's first time subscribing to the product or service. A subscription may not be being renewed if this is the first time a customer is subscribing to the product or service. As a result, the fulfillment module 141 may determine that a subscription is not being renewed if this is the customer's first time subscribing to the product or service.

If the fulfillment module 141 determines that a subscription is not being renewed, the method 400 may proceed to step 407 where a new subscription may be created. To create the new subscription, the fulfillment module 141 may create a new unique subscription ID. When creating the new subscription, the fulfillment module 141 may also assign an appropriate renewal date to the new unique subscription ID. Once the new subscription is created, it may be stored in the subscription data subsystem 111. Conversely, if the fulfillment module 141 determines that the subscription is being renewed, the method 400 may proceed to step 408. At step 408, the fulfillment module 141 may update an existing subscription. To update an existing subscription, the fulfillment module 141 may update the subscription with an appropriate subscription end date. The updated subscription may be stored in the subscription data subsystem 111.

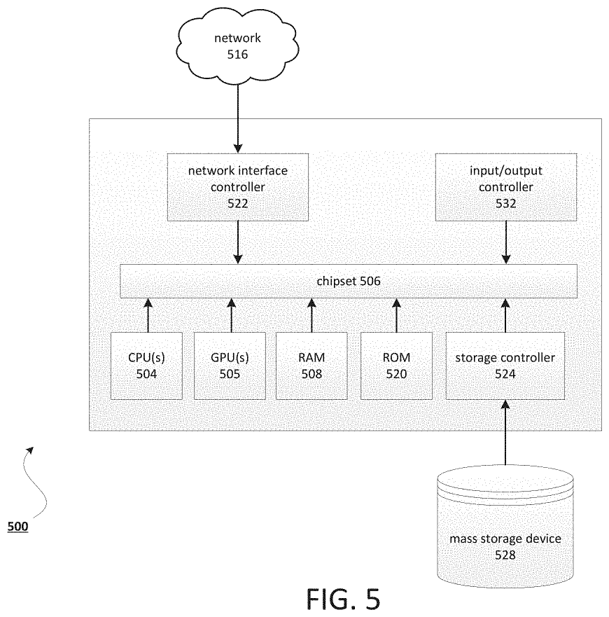

FIG. 5 depicts a computing device that may be used in various aspects of the embodiments. With regard to the example system of FIG. 1, one or more of the subscription billing system 101, the at least one user device 125, and the website 131 may be implemented in an instance of a computing device 500 of FIG. 5. The computer architecture shown in FIG. 5 shows a conventional server computer, workstation, desktop computer, laptop, tablet, network appliance, PDA, e-reader, digital cellular phone, or other computing node, and may be utilized to execute any aspects of the computers described herein, such as to implement the methods described in FIGS. 2-4.

The computing device 500 may include a baseboard, or “motherboard,” which is a printed circuit board to which a multitude of components or devices may be connected by way of a system bus or other electrical communication paths. One or more central processing units (CPUs) 504 may operate in conjunction with a chipset 506. The CPU(s) 504 may be standard programmable processors that perform arithmetic and logical operations necessary for the operation of the computing device 500.

The CPU(s) 504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 504 may be augmented with or replaced by other processing units, such as GPU(s) 505. The GPU(s) 505 may comprise processing units specialized for but not necessarily limited to highly parallel computations, such as graphics and other visualization-related processing.

A user interface may be provided between the CPU(s) 504 and the remainder of the components and devices on the baseboard. The interface may be used to access a random access memory (RAM) 508 used as the main memory in the computing device 500. The interface may be used to access a computer-readable storage medium, such as a read-only memory (ROM) 520 or non-volatile RAM (NVRAM) (not shown), for storing basic routines that may help to start up the computing device 500 and to transfer information between the various components and devices. ROM 520 or NVRAM may also store other software components necessary for the operation of the computing device 500 in accordance with the aspects described herein. The user interface may be provided by a one or more electrical components such as the chipset 506.

The computing device 500 may operate in a networked environment using logical connections to remote computing nodes and computer systems through local area network (LAN) 516. The chipset 506 may include functionality for providing network connectivity through a network interface controller (NIC) 522, such as a gigabit Ethernet adapter. A NIC 522 may be capable of connecting the computing device 500 to other computing nodes over a network 516. It should be appreciated that multiple NICs 522 may be present in the computing device 500, connecting the computing device to other types of networks and remote computer systems.

The computing device 500 may be connected to a storage device 528 that provides non-volatile storage for the computer. The storage device 528 may store system programs, application programs, other program modules, and data, which have been described in greater detail herein. The storage device 528 may be connected to the computing device 500 through a storage controller 524 connected to the chipset 506. The storage device 528 may consist of one or more physical storage units. A storage controller 524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 may store data on a storage device 528 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 528 is characterized as primary or secondary storage and the like.

For example, the computing device 500 may store information to the storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 may read information from the storage device 528 by detecting the physical states or characteristics of one or more particular locations within the physical storage units.

In addition or alternatively to the storage device 528 described herein, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 528 depicted in FIG. 5, may store an operating system utilized to control the operation of the computing device 500. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 528 may store other system or application programs and data utilized by the computing device 500.

The storage device 528 or other computer-readable storage media may also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described herein. The computing device 500 may have access to computer-readable storage media storing computer-executable instructions, which, when executed by the computing device 500, may perform the methods described in relation to FIGS. 2-4.

A computing device, such as the computing device 500 depicted in FIG. 5, may also include an input/output controller 532 for receiving and processing input from a number of input devices, such as a keyboard, a mouse, a touchpad, a touch screen, an electronic stylus, or other type of input device. Similarly, an input/output controller 532 may provide output to a display, such as a computer monitor, a flat-panel display, a digital projector, a printer, a plotter, or other type of output device. It will be appreciated that the computing device 500 may not include all of the components shown in FIG. 5, may include other components that are not explicitly shown in FIG. 5, or may utilize an architecture completely different than that shown in FIG. 5.

As described herein, a computing device may be a physical computing device, such as the computing device 500 of FIG. 5. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system, comprising:
a website including a first database;
a billing system including a first database, the billing system configured to communication with a website includes a second database; and
at least one computing device in communication with the website and the billing system, the at least one computing device configured to:
retrieve, from the second database, a plurality of customer orders;
determine that a first set of customer orders from the plurality of customer orders includes at least one subscription order;
process each customer order from the first set of customer orders to determine a first subset of customer orders including a new subscription order and a second subset of customer orders including an existing subscription order;
generate, for each customer order in the first subset, data associated with the new subscription order;
update, for each customer order in the second subset, data associated with the existing subscription order; and
send, to the first database, the data associated with the new subscription order and the updated data associated with the existing subscription order.

2. The system as recited in claim 1, wherein the at least one computing device is further configured to:
determine that a second set of customer orders from the plurality of customer orders does not include a subscription order; and
cause control of the second set of customer orders to be returned to the website without processing the second set of customer orders.

3. The system as recited in claim 1, wherein the at least one computing device is further configured to cause control of the first set of customer orders to be returned to the website after the data associated with the new subscription order and the updated data associated with the existing subscription order is sent to the second database.

4. The system as recited in claim 1, wherein the billing system further includes a payment module configured to process payment associated with customer orders.

5. The system as recited in claim 4, wherein the at least one computing device is further configured to, before determining that the first set of customer orders from the plurality of customer orders includes a subscription order:
determine that the payment module has not successfully processed payment associated with at least one customer order from the plurality of customer orders; and
return control of the at least one customer order to the website.

6. The system as recited in claim 1, wherein each customer order from the plurality of customer orders is received by the website from at least one user device located remote to the website and the billing system.

7. The system as recited in claim 1, wherein each customer order from the plurality of customer orders comprises at least one product or service ordered by a customer and a payment status of the customer order.

8. The system as recited in claim 1, wherein the website is configured to process non-subscription orders for a live events company.

9. A method, comprising:
retrieving, from a first database associated with a website, a plurality of customer orders;
determining that a first set of customer orders from the plurality of customer orders includes a subscription order;
processing each customer order from the first set of customer orders to determine a first subset of customer orders including a new subscription order and a second subset of customer orders including an existing subscription order;
generating, for each customer order in the first subset, data associated with the new subscription order;
updating, for each customer order in the second subset, data associated with the existing subscription order; and
sending, to a second database associated with a billing system, the data associated with the new subscription order and the updated data associated with the existing subscription order.

10. The method as recited in claim 9, further comprising:
determining that a second set of customer orders from the plurality of customer orders does not include a subscription order; and
causing control of the second set of customer orders to be returned to the web site without processing the second set of customer orders.

11. The method as recited in claim 9, wherein retrieving, from the first database associated with the website, the plurality of customer orders comprises:
receiving, from the website, a plurality of order identification numbers; and
retrieving, from the first database, the plurality of customer orders corresponding to the plurality of order identification numbers.

12. The method as recited in claim 9, wherein retrieving, from the first database associated with the website, the plurality of customer orders comprises:
retrieving, for each customer order in the plurality of customer orders, at least one product or service ordered by a customer and a payment status of the customer order.

13. The method as recited in claim 9, wherein generating, for each customer order in the first subset, data associated with the new subscription order comprises:
creating an identifier for the new subscription order; and
assigning a subscription renewal date to the identifier.

14. The method as recited in claim 9, wherein updating, for each customer order in the second subset, data associated with the existing subscription order comprises:
modifying a subscription end date associated with the existing subscription order.

15. A system, comprising:
a website including a first database;
a billing system separate from the website including a second database; and
at least one computing device in communication with the website and the billing system, the at least one computing device configured to:
retrieve, from the first database, a plurality of customer orders;
determine that a first subset of customer orders from the plurality of customer orders includes at least one subscription order;
process each customer order from the first subset of customer orders to generate subscription data associated with each subscription order; and
send, to the second database, the subscription data.

16. The system of claim 15, wherein the at least one computing device is further configured to:
determine that a second subset of customer orders from the plurality of customer orders does not include a subscription order; and
cause control of the second subset of customer orders to be returned to the website without processing the second set of customer orders.

17. The system of claim 15, wherein the at least one computing device is further configured to cause control of the first subset of customer orders to be returned to the website after processing the first subset of customer orders.

18. The system of claim 14, wherein the subscription data comprises at least one of an identifier for the subscription order, a subscription renewal date for the subscription order, or a modified subscription end date for the subscription order.

19. The system of claim 14, wherein each of the plurality of customer orders comprises at least one product or service ordered by a customer and a payment status.

20. The system of claim 14, wherein the website is configured to process orders that do not include a subscription order.
